(19) United States
(12) Patent Application Publication
(10) Pub. No.: US 2023/0234053 A1
(43) Pub. Date: Jul. 27, 2023

(54) FLOW CELL WITH PREDETERMINED BREAKING BARRIER

(71) Applicant: THINXXS MICROTECHNOLOGY GMBH, Zweibrücken (DE)

(72) Inventors: Lutz WEBER, Münchweiler (DE); Stefan LEIDHEISER, Dahn (DE)

(21) Appl. No.: 17/926,716

(22) PCT Filed: May 18, 2021
(86) PCT No.: PCT/EP2021/063055

§ 371 Date: Nov. 21, 2022

(30) Foreign Application Priority Data
May 22, 2020 (EP) 20176011.3

(51) Int. Cl. B01L 3/00

(52) U.S. Cl. CPC B01L 3/502738; B01L 2300/123; B01L 2200/0689; B01L 2400/0655

(57) ABSTRACT

A flow cell with a predetermined breaking barrier in a duct region of the flow cell. The flow cell has a cut-out in a substrate of the flow cell, which forms a portion of the duct region and has an opening in a surface of the substrate. The opening is hermetically sealed by a barrier film fused and/or glued to the surface and forming the predetermined breaking barrier. A layer is provided to be arranged over the barrier film. The layer can be stretched into the cut-out on breaking of the barrier film and formation of an access to a duct region section bounded by the barrier film and the layer.

The invention relates to a flow cell with a predetermined breaking barrier in a duct region of the flow cell.

As is known, microfluidic flow cells as used, for example, in medical diagnostics for analyzing biological samples are becoming increasingly important. Such flow cells, usually combined with an operating unit, comprise sometimes complex networks of ducts, storage chambers, and reaction chambers. In order to hermetically enclose stored reagents, such flow cells have predetermined breaking barriers which are to be broken open during operation.

Flow cells with predetermined breaking barriers are disclosed, for example, in DE 10 2007 059 553 A1, EP 2 679 307 A1, and PCT/EP2018/058670.

The present invention provides a novel flow cell of the type mentioned at the beginning which is characterized by at least one recess in a substrate of the flow cell which forms part of the duct region and has an opening in an upper surface of the substrate, wherein the opening is hermetically sealed by a barrier film fused or/and bonded to the upper surface and forming the predetermined breaking barrier, and by an elastic layer which is provided for arrangement above the barrier film and can be stretched into the recess, breaking the barrier film and affording access to a duct region section bounded by the barrier film and the layer. The breaking open of the barrier film affords access to a duct region section, adjoining the recess, with a flow cross-section bounded by the barrier film and the elastic layer through which the onward transport of fluid inside the flow cell can take place.

In an embodiment of the invention, the substrate forms, in an edge region adjoining the opening of the recess, a valve seat onto which the elastic layer and the barrier film can be pressed, fluidtightly separating the duct region section from the recess. The elastic layer and the barrier film then form a seal along the valve seat which prevents a transporting flow between the elastic layer and the barrier film.

In a particularly preferred embodiment, the barrier film and/or the elastic layer extend/extends over a plurality of recesses, each forming part of a duct region, with an opening in the upper surface of the substrate. In this way, in an efficient production process, multiple predetermined breaking barriers and valves situated downstream from the latter can advantageously be created with a single barrier film or/and elastic layer.

It should be understood that the layer can be stretched by a pin element which is part of an operating mechanism for the flow cell and can be pushed forward in particular perpendicularly against the elastic layer.

The pin element can preferably be moved using a drive mechanism in order to perforate the barrier film, for example when it is pushed forward, and to enable fluid to flow through the breaking point, for example when it is withdrawn.

The pin element is preferably arranged coaxially with the opening which is expediently a circular opening. A uniform contact pressure along the valve seat occurs as a result of such a pin element.

The pin element expediently has a cross-section which reduces in the direction in which it is pushed forward, wherein the cross-section of the pin element increases in particular counter to the direction in which it is pushed forward to a value which is greater than the cross-section of the opening. Abutment against the flow cell which limits the amount by which the pin element is pushed forward thus occurs in the edge region forming the valve seat, as a result of which a secure valve seal is enabled.

In the sealing position of the pin element, the elastic layer and the barrier film are preferably clamped between the valve seat and a section with a cross-section which reduces in the direction in which it is pushed forward or an annular shoulder of the pin element such that a high surface pressure results between the elastic layer and the barrier film which ensures the fluidtight sealing of the duct region section. The recess is expediently widened, in particular conically widened, in the edge region forming the valve seat and adjoining the opening of the recess. The edge region at the transition from the recess into the upper surface of the substrate can also be rounded.

In a further embodiment, the elastic layer is bonded or/and fused to the barrier film in a surface region adjoining the duct region section or is simply pressed fluidtightly against the barrier film by a punch element of the operating mechanism.

The elastic layer can thus be an integral part of the flow cell, an integral part of the operating mechanism, or a separate, replaceable intermediate layer. Advantageously, no fluid can escape from the flow cell in the first case.

The elastic layer just lies loosely on the barrier film in the region of the duct region section and can be stretched by internal fluid pressure or external suction pressure, forming a flow cross-section between the elastic layer and the barrier film.

Alternatively, the elastic layer can be permanently deformed in the duct region section, forming a flow cross-section between the layer and the barrier film.

In a further preferred embodiment of the invention, the recess or/and the pin element are designed in such a way that, in a pushed-forward position of the pin element in which the elastic layer is stretched into the recess, the duct region section is fluidically connected to the recess. Such an embodiment without the valve function downstream from the predetermined breaking barrier can advantageously make use of operating devices with spring-loaded pin elements which can no longer move after contacting the flow cell.

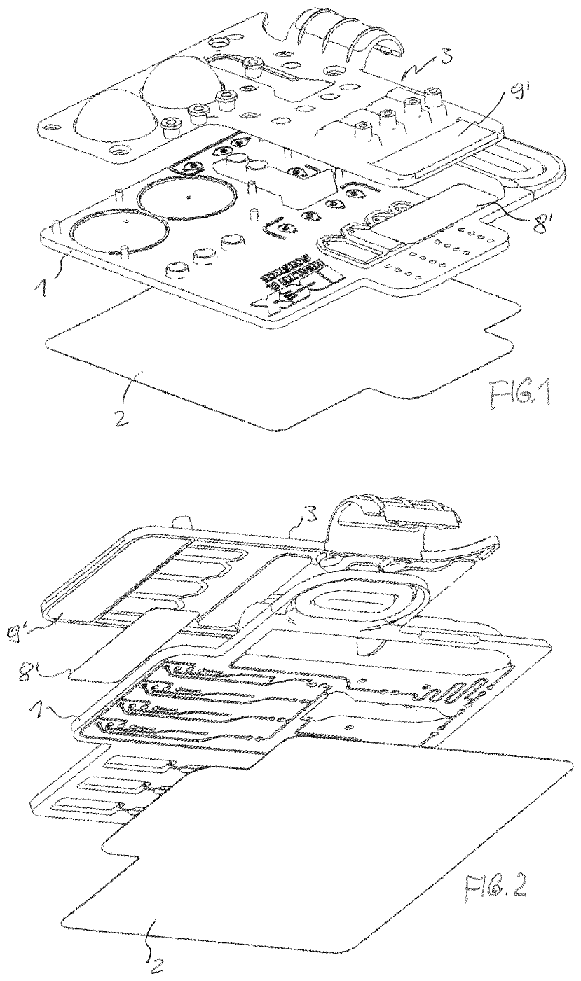

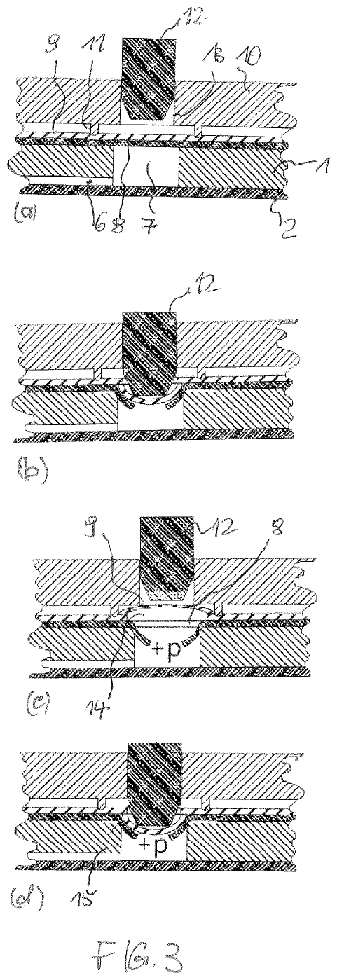

FIGS. 1 and 2 exploded illustrations of a flow cell according to the invention in different perspective views,

FIG. 3 a detail of a flow cell according to the invention with a valve function in different positions of a pin element, supplementing the valve, of an operating device,

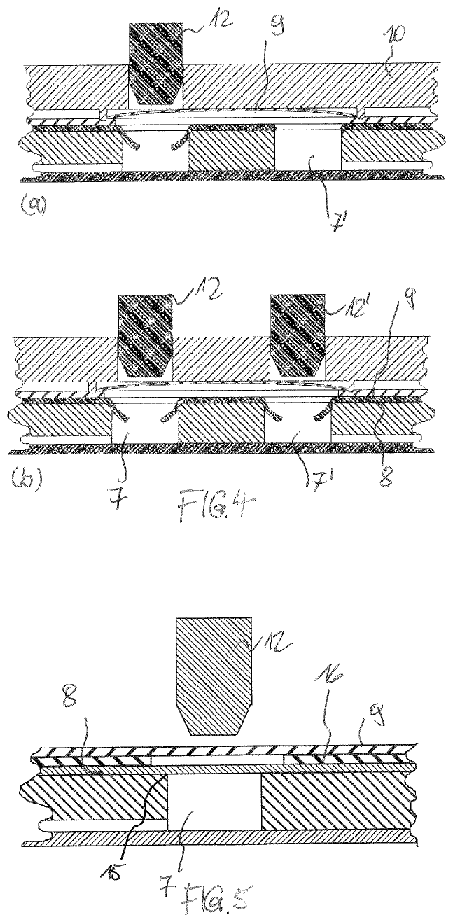

FIG. 4 two variants of flow cells according to FIG. 3,

FIG. 5 a detail of a flow cell according to a second exemplary embodiment for the invention,

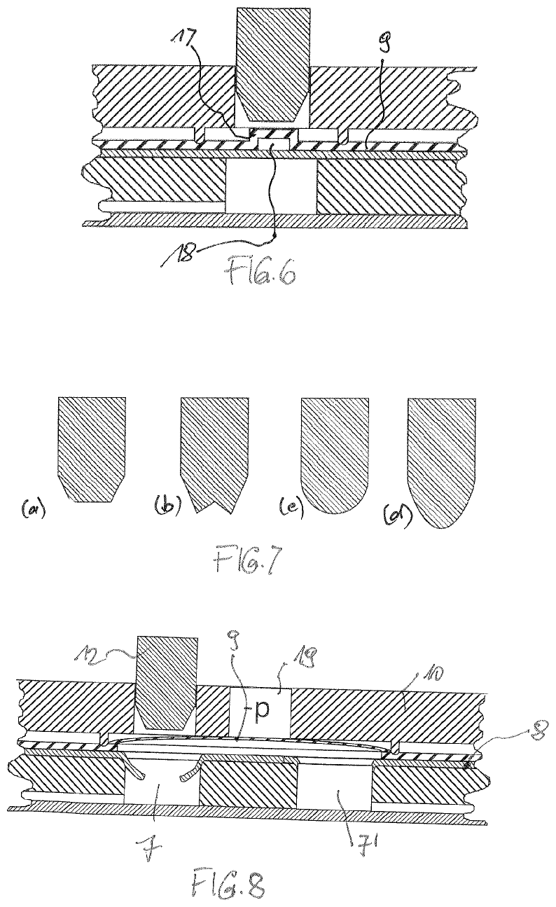

FIG. 6 a detail of a flow cell according to a third exemplary embodiment for the invention,

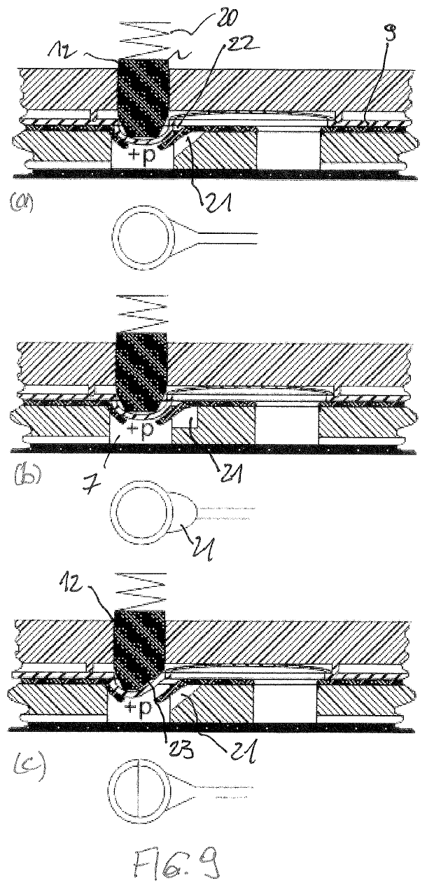

FIG. 7 different variants of a pin element, which can be used in a flow cell according to the invention, of an operating device,

FIG. 8 a fourth exemplary embodiment for a flow cell according to the invention,

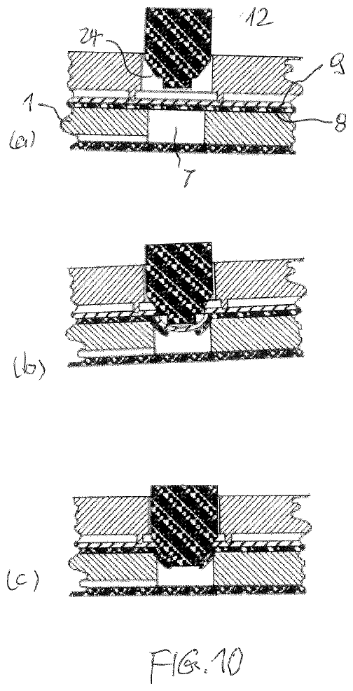

FIG. 9 different variants of a flow cell according to a fifth exemplary embodiment, and

FIG. 10 an exemplary embodiment for a pin element of an operating mechanism.

A flow cell shown in FIGS. 1 and 2 in different perspective views and in an exploded illustration and designed with the basic form of a plate has four main components, a substrate 1 preferably injection-molded from plastic, which is covered on its underside by a film 2 and is connected on its upper side to a housing component 3. Moreover, connected to the substrate 1 is a film 8′ which is preferably produced as a composite film consisting of aluminum and plastic. The housing component 3 produced by the injection-molding of multiple components comprises as a soft component an elastic layer 9′ which essentially comes to cover the film 8′.

As can be seen in FIGS. 1 and 2, in addition to a network of ducts, the flow cell comprises multiple functional regions, including in particular storage and reaction chambers. Some of the functional regions work together to supplement an operating device for the flow cell. The latter applies in particular for mechanisms of the flow cell which are described below with the aid of FIGS. 3-10.

FIG. 3 shows a detail of a flow cell, for example the flow cell from FIGS. 1 and 2. A substrate 1 is covered on an underside by a film 2 bonded or/and fused to the substrate 1. The film 2 bounds a duct region formed in the substrate 1 by a duct recess 6 and a circular cylindrical recess 7. The duct region moreover comprises a supply chamber, for example for a reagent, into which the duct recess 6 opens (not shown). A barrier film 8 covering the recess 7 is arranged on the upper side, facing away from the film 2, of the substrate 1. Because the barrier film 8 is bonded or/and fused to the upper surface of the substrate 1, it hermetically closes the recess 7. In the example, the barrier film 8 is a composite film consisting of a plastic layer and a metal layer, in particular an aluminum layer. The plastic layer faces the recess 7. The barrier film 8 can be formed, for example, by the film 8′ shown in FIGS. 1 and 2.

Whilst the barrier film 8 is firmly connected to the substrate 1, an elastic layer 9 arranged above the film 8 lies only loosely against the barrier film 8 in the region shown in FIG. 3. The layer 9 can be an integral part of the layer 9′ of the housing component 3 shown in FIGS. 1 and 2 where it is fixed to edges (not visible in FIG. 3) in the manner of a frame and immobilized in a direction parallel to the upper surface of the substrate. A punch element 10 of an operating device for the flow cell lies against the layer 9. The punch element 10 has a projecting web 11, in the form of a closed ring, by means of which the elastic layer 9 is pressed fluidtightly against the barrier film 8 fused or/and bonded to the substrate 1 and is thus immobilized on the barrier film 8 parallel to the upper surface of the substrate. The annular web 11 encloses the opening of the recess 7 and, in the example, of a further recess 7′ in the substrate 1 (FIG. 4) in each case spaced apart from the edge of the opening.

A pin element 12, which can be displaced in a guide 13 in the punch element 10 perpendicularly to the plane of the plate of the substrate 1 and is arranged coaxially with the cylinder axis of the recess 7.

As can be seen in FIG. 3b, the pin element 12 can be extended out of the punch element, wherein it stretches the elastic layer 9 into the recess 7 until the barrier film 8 which hermetically closes the supply chamber for the duct region containing reagent finally ruptures. In the position of the pin element 12 shown in FIG. 3b, this duct region nevertheless remains closed because the layer 9 lies fluidtightly against the opening edge, forming a valve seat (and covered only by the thin barrier film 8), of the recess 7, as explained further below. When the pin element 12 returns into the position shown in FIG. 3c, by applying a pressure (+p) to a fluid in the duct region, the fluid pressure then acting on the layer 9 through the broken-open barrier film 8, the elastically stretchable layer 9 can be freed up to form a further duct region section 14 between the layer 9 and the film 8, through which fluid can flow into the recess 7′ (FIG. 4).

Movement of the pin element 12 from this open position back into the position shown in FIGS. 3b and 3d causes the flow path from the recess 7 into the intermediate space formed between the layer 9 and the film 8 to be closed by the layer 9 being drawn over the opening edge 15, covered by the film 8, of the recess 7 and being deflected at the opening edge such that a more or less uniformly high surface pressure and hence fluidtight sealing of the flow path result around the opening edge.

It should be understood that the recess 7′ shown in FIG. 4a does not need to have the same dimensions as the recess 7. In the example shown, according to FIG. 4b, the second recess 7′ can, however, also serve as a valve recess sealed by the barrier film 8 and form a valve seat which can be opened and closed by displacement of a further pin element 12′ after the film 8 has been broken open.

In an embodiment shown in FIG. 5, the layer 9 does not need to be pressed against the film 8 in a surface region which bounds the further duct region section 11. In the exemplary embodiment in FIG. 5, the layer 9 is connected fluidtightly to the barrier film 8 in this surface region, by a double-sided adhesive film 16 in the example shown. As can be seen in FIG. 5, the connecting region is set back from the opening edge 15 of the recess 7 over the whole opening circumference. When the layer 9 is stretched into the recess 7 by a pin element 12 coaxial with the opening edge, that region of the layer 9 which projects over the opening edge 15 advantageously also exerts a tensile force which increases the sealing effect at the opening edge 15.

According to FIG. 4b, in the open position of the pin element 12 (with the film 8 broken open), when the pin element 12′ is situated in the sealing position, liquid could pass through the duct region section 14 as far as the closed recess 7′. A determined quantity of fluid which can be drawn out of the duct region section 14 when a suction pressure is applied can be measured by the pin element 12 then being transferred into the sealing position and the pin element 12′ into the open position.

In an embodiment shown in FIG. 6, an elastic layer 9 produced by injection-molding or processed by being deep-drawn is provided in the region of the duct region section 14 with a permanent deformation 17 such that a duct space 18 for transporting fluid after the film 8 has been broken open is formed between the elastic layer 9 and the rupturable film 8. A lower pressure of the transported fluid is advantageously required in order to stretch the layer 9 to free up the duct region section 14.

As can be seen in FIG. 7, the shape of the pin element 12 used in the preceding exemplary embodiments can vary and in particular the end face, acting on the layer 9, of the pin element can be designed differently. Whilst the exemplary embodiments in FIGS. 7c and 7d have only rounded end faces, in the exemplary embodiment in FIG. 7b the end face is indented. Such an end face appears to be expedient for the exemplary embodiment described in FIG. 6.

FIG. 8 shows a flow cell according to FIG. 4a. In contrast to this alternative embodiment, however, a punch element 10 has an opening region 19 by means of which a reduced pressure (−p) can be applied to the elastic layer 9. The pressure, required to stretch the layer 9, of the fluid to be transported through the valve can thus be reduced.

Embodiments functionally limited to a predetermined breaking barrier result from FIG. 9. A pin element 12 of an operating device is acted upon by a spring 20 which holds the pin element 12 in the position shown in FIG. 9, wherein the operating device lies functionally against the elastic layer 9 of the flow cell. In the position shown, the pin element 12 has broken open the film 8. In the exemplary embodiment in FIG. 3, the recess 7 would be sealed fluidtightly by the elastic layer 9 in this position of the pin element 12.

However, in the example shown, the cylindrical recess 7 has on one side a widened portion 21 by means of which a flow passage 22 for a fluid under pressure (+p) can be formed between the broken-open film 8 and the elastic layer 9 stretched into the recess 7.

As shown in FIGS. 9a-9c, the lateral widened portion 21 can be shaped differently. In the exemplary embodiment in FIG. 9c, not only is the widened portion 21 of the cylindrical recess 7 formed but also a bevel 23, facing the widened portion 21, is formed on the pin element 12, which results in an enlarged cross-section of the flow passage 22.

In an exemplary embodiment shown in FIG. 10, a pin element 12 has an approximately conical end section 24, the maximum cross-section of which exceeds the opening cross-section of a cylindrical recess 7 in a substrate 1.

In a position, shown in FIG. 10b, in which the pin element 12 is pushed forward, a barrier film 8 has already been broken open by an elastic layer 9 stretched into the recess 7 and a duct region section adjoining the recess 7 can be freed up by the internal pressure of the fluid. In the position shown in FIG. 10c, this possibility is prevented by the conical end section 24 fluidtightly compressing the elastic layer 9 and the barrier film 8 between the conical end section 24 and a valve seat formed in the edge region of the recess 7.

Also in the exemplary embodiment shown in FIG. 3, it may be necessary to push the pin element further forward in order to seal the valve seat if the tensile force of the elastic layer is not yet sufficient to form a fluidtight barrier in the pushed-forward position in which the barrier film is ruptured.

1-14. (canceled)

15. A flow cell with a predetermined breaking barrier in a duct region of the flow cell, comprising: a substrate having at least one recess that forms part of the duct region and has an opening in an upper surface of the substrate; a barrier film that hermetically seals the opening, the barrier film being fused and/or bonded to the upper surface; and an elastic layer arranged above the barrier film so as to be stretchable into the recess to break the barrier film and afford access to a section of the duct region bounded by the barrier film and the elastic layer.

16. The flow cell according to claim 15, wherein the substrate forms, in an edge region adjoining the opening, a valve seat onto which the elastic layer and the barrier film are pressable, fluidtightly separating the section of the duct region from the recess.

17. The flow cell according to claim 15, wherein the at least one recess includes a plurality of recesses that have an opening in the upper surface of the substrate and each form part of a duct region, wherein the barrier film and/or the elastic layer extend/extends over the plurality of recesses.

18. The flow cell according to claim 16, further comprising a pin element that is part of an operating apparatus for the flow cell, the pin element being displaceable against the elastic layer so as to stretch the elastic layer into the recess.

19. The flow cell according to claim 18, wherein the pin element is displaceable perpendicularly against the elastic layer.

20. The flow cell according to claim 18, wherein the pin element is arranged coaxially with the opening.

21. The flow cell according to claim 20, wherein the opening is circular.

22. The flow cell according to claim 18, wherein the pin element has a cross-section that reduces in a direction of displacement.

23. The flow cell according to claim 22, wherein the cross-section of the pin element increases counter to the direction of displacement to a value that is greater than a cross-section of the opening.

24. The flow cell according to claim 22, wherein, in a sealing position, the pin element, the elastic layer and the barrier film are clamped between the valve seat and a section with a cross-section which reduces in the direction of displacement or an annular shoulder of the pin element.

25. The flow cell according to claim 18, wherein the opening is widened in the edge region forming the valve seat.

26. The flow cell according to claim 25, wherein the opening is conically widened in the edge region forming the valve seat.

27. The flow cell according to claim 18, wherein the elastic layer is bonded and/or fused to the barrier film in a surface region adjoining the section of the duct region or is pressable fluidtightly against the barrier film by the pin element of the operating mechanism.

28. The flow cell according to claim 18, wherein the elastic layer is an integral part of the flow cell or the operating mechanism.

29. The flow cell according to claim 15, wherein the elastic layer lies loosely on the barrier film in a region of the section of the duct and is stretchable by fluid pressure and/or external suction pressure so as to form a flow cross-section between the elastic layer and the barrier film.

30. The flow cell according to claim 18, wherein the elastic layer is permanently deformed in the duct region section to form a flow passage between the layer and the barrier film.

31. The flow cell according to claim 18, wherein the recess and/or the pin element are configured so that, in a pushed-forward position of the pin element in which the elastic layer is stretched into the recess, the section of the duct region is fluidically connected to the recess.
